(19) United States
(12) Patent Application Publication
(10) Pub. No.: US 2016/0171988 A1
(43) Pub. Date: Jun. 16, 2016

(54) DELAY ESTIMATION FOR ECHO CANCELLATION USING ULTRASONIC MARKERS

(71) Applicant: Wire Swiss GmbH, Zug (CH)

(72) Inventors: Koen Bernard Vos, Singapore (SG); Søren Skak Jensen, Frederiksberg (DK)

(21) Appl. No.: 14/935,414

(22) Filed: Nov. 8, 2015

Related U.S. Application Data
(60) Provisional application No. 62/091,661, filed on Dec. 15, 2014.

(51) Int. Cl. G10L 21/02; G10L 21/0232; G01S 1/72

(52) U.S. Cl. CPC G10L 21/0205; G01S 1/725; G10L 21/0232; G10L 2021/02082

(57) ABSTRACT

A far end signal is received at a device, a marker signal is inserted into the far end signal and the far end signal with the marker signal is played on a speaker. A near end signal is received via a microphone and the marker signal is detected in said received near end signal. The detected marker signal is used to determine a delay that is then used to cancel at least some of an echo in the near end signal. The marker may be ultrasonic. The echo canceller and other processing may run at a lower sampling frequency than the marker detection.

### RELATED APPLICATIONS

This application is related to and claims priority from U.S. Provisional Patent Application No. 62/091,661, titled “Delay Estimation for Echo Cancellation Using Ultrasonic Markers,” filed Dec. 15, 2014, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

1. Field of the Invention

This invention relates to communication systems, and, more particularly, to echo reduction in digital communication systems.

2. Background

Digital communications have become ubiquitous. In a typical digital communication system users may connect to each other via a communication network such as the Internet or the like and may exchange information such audio (e.g., speech) or video data in real time. Signals, including audio signals, may be transmitted between nodes of the communication network from one user to one or more other users.

Each user may have a user device with which to communicate with one or more other devices via the network. Each device has an audio input means, e.g., a microphone or the like and some means of audio output, e.g., a speaker or the like. For devices involved in a conversation, sounds picked up by microphone of a device are converted from analog to digital form and then sent to other devices in current communication with the device.

When a loudspeaker on a device plays sound, and a microphone on the same device captures this sound a fraction of a second later, the captured sound is referred to as an echo. Left untreated, such echoes can be disturbing to remote users in a voice call, who, because of the echoes, hear themselves back. Echo cancellers serve the purpose of removing such echoes.

Consider a typical situation, with reference to FIG. 1, in which a signal from a remote location (a far end) is received at a device (the near end). The signal, which may be in digital form, is used to generate sound through a speaker. A nearby microphone is being used at the same time to pick up near-end audio (e.g., voice from the user) and to send that audio to the far end (to other devices in conversation with this user). However, in addition to any near-end voice, the microphone also picks up near-end noise and sound generated by the speaker (the so-called echo signal). Absent remedial processing, the signal being returned from the near end to the far end will include the echo signal. It is thus desirable to remove the echo signal from the return signal. In some cases this is done by determining an estimate of the echo signal (shown in the drawing as “echo estimate”) and removing (e.g., subtracting) that estimated echo from the return signal before sending the return signal to the far end (i.e., to other devices).

There are two broad techniques for removing echoes: echo cancellation, which subtracts an estimate of the echo signal from the microphone signal; and echo suppression, which suppresses the microphone signal over time and frequency, depending on how much echo is present. This invention relates to both methods, and we will use the term echo cancellation to mean either method.

A critical component in many echo cancellers is a delay estimation module, which estimates the time it takes from sending the far end signal to the loudspeaker until it comes back as an echo in the near end signal from the microphone. Echo cancellers normally use this estimate to delay the far end signal by the same amount before it goes into the actual subtraction or suppression module, thus aligning the far end and echo signals in time.

The delay estimation module is especially important in software-based echo cancellers, where buffers may have unknown and potentially time-varying delay. Such buffers exist in the incoming and outgoing streams, both in hardware and in the Operating System (OS), as shown in FIG. 2. As used herein, software means code running in user space as opposed to code running in the Operating System or in hardware (often denoted firmware) that cannot be altered or accessed by typical applications. As shown in FIG. 2, the software (SW) sends the far end signal, through buffers in the operating system (OS) and hardware (HW), to the loudspeaker. The microphone captures the sound from the loudspeaker and passes it through more buffers back to the software, where it arrives with a certain delay in the near end signal.

State of the art methods typically estimate the delay by trying to correlate the far end signal with the near end signal. In an ideal situation the far end signal would contain speech from the remote side and the near end signal would contain the echo of that speech, and the correlation measure would contain a single sharp peak at a correlation lag equal to the delay. Unfortunately, however, this approach suffers from the dependency on the speech signal. The near end signal may contain other signals besides the echo, such as strong background noise or a loud near end voice signal. Furthermore, the echo signal may be distorted by imperfections in the system or by overloading the microphone. Still further, speech signals often have a strong periodic character. In light of these effects, the correlation measure is often noisy, has a broad peak and contains spurious peaks, making correlation-based estimates unreliable. Much effort has gone into finding heuristics to improve the robustness of correlation-based estimates, with limited success.

Another problem with this correlation-based approach is that the delay estimate cannot be updated when the far end signal is silent. As a result the delay estimate may be off by the time the remote side starts speaking. This wrong estimate can prevent the echo canceller from removing echo until the delay estimate is again accurate.

Yet a further weakness of the correlation-based method is its computational complexity. A delay estimation module often accounts for a large part of an echo canceller's CPU usage.

It is desirable to have an echo cancellation technique that is robust, reliable, and not computationally expensive.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1 and 2 describe aspects of echo and echo cancellation;

FIG. 3 shows aspects of a communication device according to exemplary embodiments hereof;

FIG. 4 is a flowchart showing operational aspects of exemplary embodiments hereof; and

FIG. 5 shows an example framework using devices according to exemplary embodiments hereof.

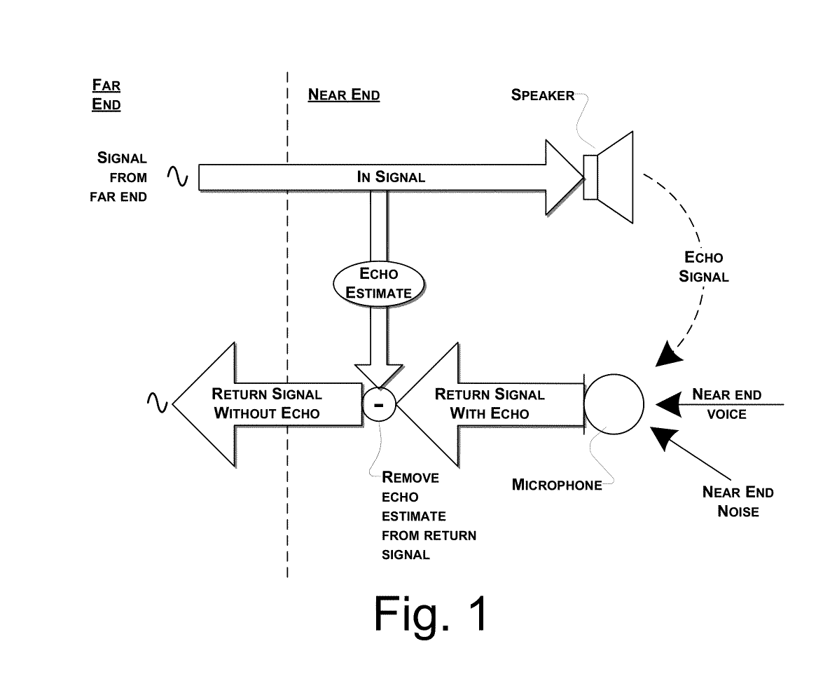

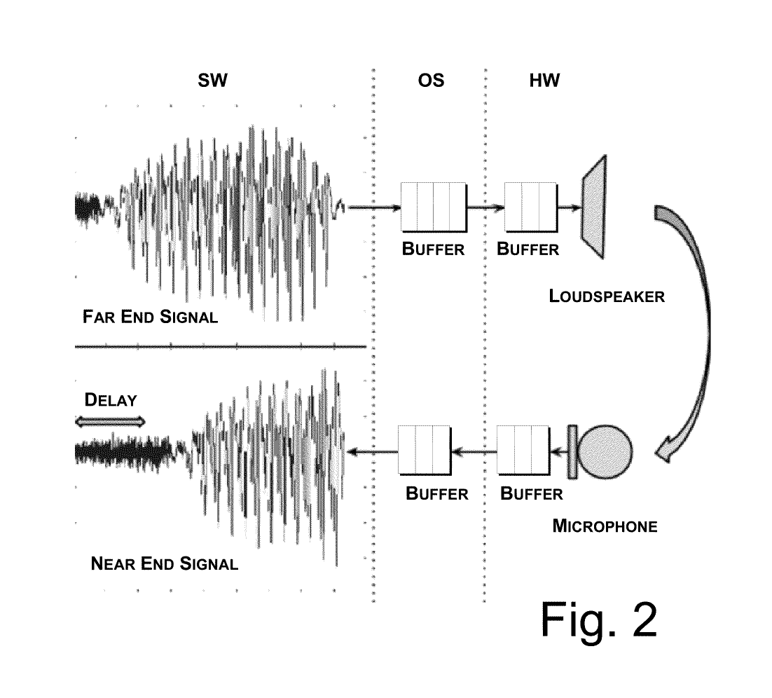

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

VoIP means Voice over IP.

A “mechanism” refers to any device(s), process(es), routine(s), service(s), module(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### DESCRIPTION

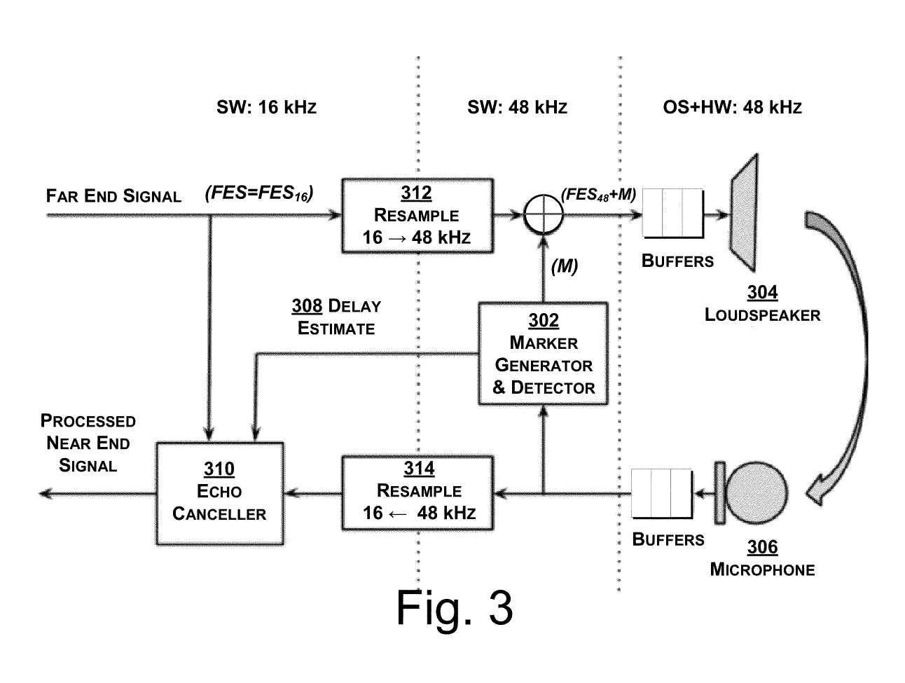

As shown in the drawing in FIG. 3, showing aspects of a communication device 300 according to exemplary embodiments hereof, a marker generator and detector mechanism 302 adds marker signals or markers (denoted M) to the far end signal (FES) before that signal is rendered by the speaker 304. The markers M may be added periodically or at random intervals, as described below. As also described below, marker signals need not all be the same. Although any signal may be used for the marker signal, preferably the marker signal is inaudible while still being detectable by the device's microphone. An example of such a marker is an ultrasonic one, located around 20 kHz in the frequency spectrum. Additional details of exemplary markers are described below.

The microphone 306 picks up the far end signal (FES) with the added marker signal (M) (possibly along with any other sounds including speech, noise, etc.). The marker generator and detector mechanism 302 may then detect the marker signal (M) in the return near end signal, thereby determining or estimating a delay associated with that signal. The estimated delay 308 may be used by the echo canceller mechanism 310 to remove the echo from the near end signal. The near end signal with the echo canceled by the echo canceller mechanism 310 is then sent to the far end.

It should be appreciated that the echo canceller mechanism 310 may not remove all of the echo in the near end signal, and that, if successful, some or all of the echo may be removed.

Although shown as a single box 302 in the drawings, it should be understood that the marker generator mechanism and marker detector mechanism may be separate components. However, the marker detector mechanism will need to know details of markers added to the far end signal in order to be able to detect and distinguish them.

Sampling Frequency

In order to play out and capture a marker signal at frequencies of around 20 kHz, the sampling frequency must be at least twice as high as the marker signal frequency. In practice that means a sampling frequency of 44.1 kHz or 48 kHz, or higher (a typical speech sampling frequency for telephony is 8 kHz, with higher quality speech being provided at a sampling frequency of 16 kHz or higher). However, this does not mean that the echo canceller and other processing must also operate at such a high sampling frequency. Only the audio input and output, and marker processing need operate at the higher frequency, while the rest of the processing can be done at a lower sampling frequency. That is, the marker generation and detection can, and preferably does, operate at a higher sampling frequency than the echo cancellation.

In the exemplary embodiment shown in FIG. 3 the arriving far end signal (denoted FES) is at 16 kHz (denoted FES₁₆ in the drawing), the marker generation and detection operate at 48 kHz, and the echo cancellation operates at 16 kHz. This requires the arriving far end signal to be resampled (by resampling mechanism 312, from 16 kHz to 48 kHz) before the marker signal is added, and the return signal (potentially having the marker signal included therein) is again resampled (by resampling mechanism 314, from 48 kHz to 16 kHz) before being provided to the echo canceller 310.

Although the arriving far end signal is shown in this embodiment as 16 kHz, that of ordinary skill in the art will realize and appreciate, upon reading this description, that different/other frequencies may be used. For example, the sample frequency of the arriving far end signal may be, without limitation, 8 kHz, 12 kHz, 16 kHz, 24 kHz, or 32 kHz.

The resampling (from 16 to 48 kHz and then back) may introduce delays. In the exemplary embodiment shown in FIG. 3 the delay estimate is passed from the marker detector 302 to the echo canceller 308, after adding additional delays due to the 16 to 48 kHz and 48 to 16 kHz resampling.

Running the echo canceller and other processing at a lower sampling frequency reduces their computational complexity.

Those of ordinary skill in the art will realize and appreciate, upon reading this description, that when a frequency is specified herein, the mechanism will operate at substantially that frequency, within acceptable limits.

Fall Back to Conventional Delay Estimation

For reasons outside the software's control, the ultrasonic markers may not always be present in the echo. For instance the loudspeaker or microphone may be unable to produce or capture the marker's high frequencies. Or the audio chain in the operating system or hardware may contain a low-pass filter that removes the markers. In these cases the device may fall back to conventional delay estimation. A practical approach is to start with the conventional estimation, and have it be overruled (and perhaps turned off) when markers are being detected in the echo.

Microphone Overload

In systems that lack analogue microphone gain control, or lack an API or the like to set the analogue microphone gain, the echo can overload the microphone, meaning that the output from the microphone or microphone electronic circuitry is distorted. This distortion makes the echo less similar, and thus less correlated, to the far end signal, thereby deteriorating a conventional delay estimate. This easily happens in a hands-free set up (speakerphone mode), where the loudspeaker is much closer to the microphone than to the near end user. The near end user may turn up the speaker volume so high that the echo reaches the microphone at a much higher level than the near end user's voice. If the microphone's analogue microphone gain is tuned to pick up the near end user, then the louder echo will overload. The invention solves this problem because the marker signal does not have to reach the near end user's ear, so that it may be played at a lower level and thereby avoid overloading the microphone. This helps with accurately detecting markers.

Marker Interval

The time interval at which markers are generated (referred to as the marker interval) determines how fast the delay estimate can follow changes in the true delay. The shorter the marker interval, the faster it can follow. However, if the marker interval becomes shorter than the known range of the true delay, uncertainty arises about which marker is being detected. For example, if markers are generated every 500 ms, and the delay range is from 100 to 1000 ms, then a detection at 200 ms after generating a marker is followed by another detection at 700 ms. In order to resolve this ambiguity, consecutive markers may differ such that the detector can tell them apart.

Another reason for using variable markers is to be immune from nearby devices that use the same type of markers. Any detected markers that differ from markers that were recently played out must come from a different device and are simply ignored.

When the markers are not all the same then the marker generator and detector mechanism 302 preferably tracks markers that have been generated and looks for those markers in the return signal. Markers may be tracked by the mechanism by being stored in a table or buffer or the like. It should be appreciated that the mechanism 302 need only store enough recent markers to cover the expected maximum delay range for the selected marker interval.

Randomized Marker Interval

Two nearby devices may still interfere with each other if they happen to play their markers at exactly the same time. The remedy is to (randomly) vary the interval between consecutive markers, so that each marker is played after a different interval than the one before. As a result, most of the time markers from nearby devices will not overlap in time. As should be appreciated, an occasionally lost or missed marker poses no problem.

Generating Versus Storing

Some embodiments hereof may trade memory for computational processing by generating markers only once, and storing them. Markers are then simply read from memory when needed.

Choosing a Marker Signal

Since a marker signal is preferably inaudible to humans, a particular implementation may freely optimize the marker signal for its purpose of delay estimation. While any marker signals may be used, desirable (though not required) properties of a marker signal are:
Robustness against a non-flat frequency response of the audio chain.
Robustness against reverberation.
Robustness against nonlinear distortion.
Robustness against high background noise.
Good time resolution. In the order of 10 ms, or better.
Ability to generate and detect different versions. In other words, ability to encode and decode a message in the marker.
Modest computational requirements for generation and detection.

Those of ordinary skill in the art will realize and appreciate, upon reading this description that most of these requirements overlap with those of ultrasonic inter-device communications. In that area, a known and proven method uses Orthogonal Frequency Division Modulation (OFDM) to encode a message into a signal, often in combination with Forward Error Correction (FEC) for robustness, e.g., as described in Matsuoka, Hosei, Yusuke Nakashima, and Takeshi Yoshimura. “Acoustic communication with OFDM signal embedded in Audio,” Audio Engineering Society Conference: 29th International Conference: Audio for Mobile and Handheld Devices, Audio Engineering Society, 2006. Those of ordinary skill in the art will realize and appreciate, upon reading this description that this approach also works well for the purpose of this invention.

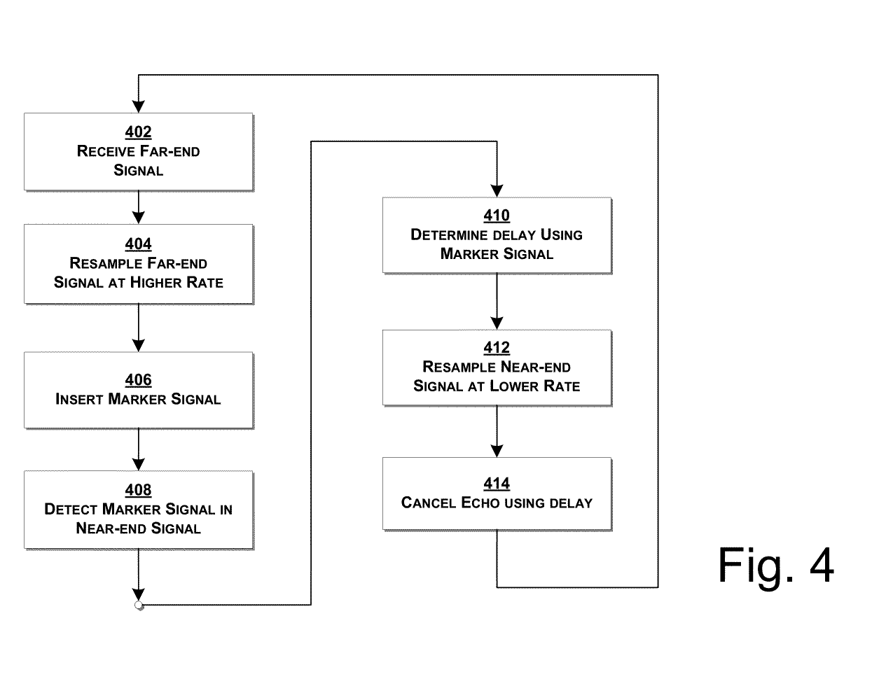

Exemplary operation of aspects of embodiments hereof is described with reference to the flowchart in FIG. 4. A device receives a far end signal (at 402) and, if necessary, resamples the incoming far-end signal at a higher sampling rate (at 404). For example, the far-end signal may have been sampled at 16 kHz and it is resampled at, e.g., 44.1 kHz or 48 kHz. As should be appreciated, it depending on the sample rate of the incoming far-end signal, it may not actually be necessary to resample the signal. The device inserts a marker signal into the far-end signal (at 406) before that signal is rendered (e.g., played on a speaker of the device). The device then tries (at 408) to detect the marker signal in a near-end signal (received, e.g., at the device from the device's microphone). If a marker signal is detected (at 408) then the device determines (at 410) the delay to be used by a subsequent echo cancellation.

The near end signal (with any echo and marker) is resampled (if necessary) at a lower rate (at 412). The delay (determined at 410) is then used to cancel the echo in the near-end signal (at 414).

### Example

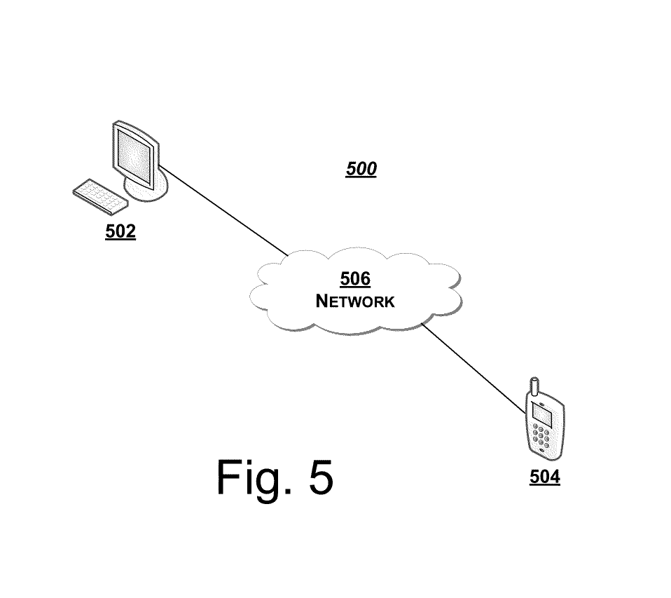

FIG. 5 shows an example framework 500 in which devices, including device 502 and device 504 communicate via one or more networks 506. The devices 502 and 504 may use VoIP systems to communicate. Other devices (not shown) may also use the system. The network(s) 506 may include the Internet. The devices 502 and 504 may be computer devices such as laptop computers, tablet computers, desktop computers, smartphones, set-top boxes, or the like. One or more of the devices 502, 504 may include the echo cancellation mechanisms described herein.

In some embodiments the devices operate, at least in part, in a framework such as described in: (a) U.S. patent application Ser. No. 14/311,291, filed Jun. 21, 2014, titled “Unified And Consistent Multimodal Communication Framework,” and/or (b) U.S. patent application Ser. No. 14/536,590, filed Nov. 8, 2014, titled “Voice In A Unified And Consistent Multimodal Communication Framework,” the entire contents of both of which are hereby fully incorporated herein by reference for all purposes.

Real Time

Those of ordinary skill in the art will realize and understand, upon reading this description, that, as used herein, the term “real time” means near real time or sufficiently real time. It should be appreciated that there are inherent delays in network-based communication (e.g., based on network traffic and distances), and these delays may cause delays in data reaching various components Inherent delays in the system do not change the real-time nature of the data. In some cases, the term “real-time data” may refer to data obtained in sufficient time to make the data useful for its intended purpose.

Although the term “real time” may be used here, it should be appreciated that the system is not limited by this term or by how much time is actually taken. In some cases, real time computation may refer to an online computation, i.e., a computation that produces its answer(s) as data arrive, and generally keeps up with continuously arriving data. The term “online” computation is compared to an “offline” or “batch” computation.

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

We claim:

1. A method comprising, at a device:
(A) receiving a far end signal;
(B) inserting a marker signal into said far end signal;
(C) rendering said far end signal with said marker signal on a speaker;
(D) receiving a near end signal via a microphone;
(E) attempting to detect said marker signal in said received near end signal;
(F) based on said attempting to detect in (E), determining a delay; and
(G) attempting to cancel at least some of an echo in said near end signal using said delay.

2. The method of claim 1 wherein said far end signal received in (A) was sampled at a first sample frequency, the method further comprising:
(A)(2) resampling the far end signal at a second sample frequency prior to inserting the marker signal, wherein the second sample frequency is higher than the first sample frequency.

3. The method of claim 2 wherein said near end signal received in (D) is at said second sample rate, the method further comprising:
(G)(1) resampling the near end signal received in (D) at said first sample rate prior to said attempting to cancel said echo in (G).

4. The method of claim 1 wherein the marker signal is an ultrasonic signal.

5. The method of claim 1 wherein the marker signal is around 20 kHz.

6. The method of claim 1 further comprising:
(H) inserting a second marker signal into said far end signal;
(I) rendering said far end signal with said second marker signal on said speaker;
(J) receiving a second near end signal via said microphone;
(K) attempting to detect said second marker signal in said received second near end signal;
(L) based on said attempting to detect in (K), determining a second delay; and
(M) attempting to cancel at least some of a second echo in said second near end signal using said second delay.

7. The method of claim 6 wherein said second marker signal inserted in (H) is distinct from the marker signal inserted in (B).

8. The method of claim 2 wherein the first sample frequency is selected from: 8 kHz, 12 kHz, 16 kHz, 24 kHz, and 32 kHz.

9. The method of claim 2 wherein the second sample frequency is selected from: 44.1 kHz and 48 kHz.

10. A method comprising, at a device:
(A) inserting a marker signal into a far end signal;
(B) receiving a near end signal via a microphone associated with the device;
(C) determining a delay based on said marker signal in said received near end signal;
(D) attempting to cancel an echo in said near end signal using said delay.

11. The method of claim 10 wherein the marker signal is an ultrasonic signal.

12. The method of claim 10 wherein the marker signal is around 20 kHz.

13. The method of claim 10 wherein
the attempting to cancel the echo in (D) uses the near end signal at a first sample frequency, and wherein
the determining of the delay in (C) uses the near end signal at a second sample frequency, and wherein second sample frequency distinct from the first sample frequency.

14. The method of claim 11 wherein the second sample frequency is higher than the first sample frequency.

15. The method of claim 11 wherein the first sample frequency is selected from: 8 kHz, 12 kHz, 16 kHz, 24 kHz, and 32 kHz.

16. The method claim 11 wherein the second sample frequency is selected from: 44.1 kHz and 48 kHz.

17. A method comprising, at a device:
(A) inserting one or more marker signals into a far end signal;
(B) receiving a near end signal via a microphone associated with the device;
(C) determining at least one delay based on said one or more marker signals in said received near end signal;
(D) attempting to cancel at least one echo in said near end signal using said at least one delay.

18. The method of claim 17 wherein each of the one or more marker signals is an ultrasonic signal.

19. The method of claim 17 wherein each of the one or more marker signals is around 20 kHz.

20. The method of claim 17 wherein the one or more marker signals are the same.

21. The method of claim 17 wherein the attempting to cancel the at least one echo in (D) uses the near end signal at a first sample frequency,
and wherein the determining of the at least one delay in (C) uses the near end signal at a second sample frequency distinct from the first sample frequency.

22. The method of claim 17 wherein the first sample frequency is selected from: 8 kHz, 12 kHz, 16 kHz, 24 kHz, and 32 kHz.

23. The method claim 17 wherein the second sample frequency is selected from: 44.1 kHz and 48 kHz.

24. A method comprising:
(A)(1) receiving a far end signal sampled at a first sample frequency;
(A)(2) resampling the far end signal at a second sample frequency prior to inserting the marker signal, wherein the second sample frequency is higher than the first sample frequency; and then
(B) inserting at least one ultrasonic marker signal into said far end signal after said resampling in (A)(2); and then
(C) rendering said far end signal with said at least one ultrasonic marker signal on a speaker.

25. The method of claim 24 wherein said at least one ultrasonic marker signal comprises a plurality of ultrasonic marker signals.

26. The method of claim 25 wherein said plurality of ultrasonic marker signals are inserted in (B) at substantially equal time intervals between consecutive marker signals.

27. The method of claim 25 wherein said plurality of ultrasonic marker signals are inserted in (B) at distinct time intervals between consecutive marker signals.

28. The method of claim 25 wherein the first sample frequency is selected from: 8 kHz, 12 kHz, 16 kHz, 24 kHz, and 32 kHz.

29. The method claim 25 wherein the second sample frequency is selected from: 44.1 kHz and 48 kHz.

30. A device comprising hardware, including a processor and a memory, the device being programmed to perform the method of claim 1.

31. The device of claim 30 wherein the device is a device selected from: a smartphone, a tablet device, a computer device, a set-top box, and a television.

32. A non-transitory tangible computer-readable storage medium comprising instructions for execution on a device, wherein the instructions, when executed, perform acts of the method of claim 1.

33. The tangible computer-readable storage medium of claim 32 wherein the device is a device selected from: a smartphone, a tablet device, a computer device, a set-top box, and a television.
